(19) United States
(12) Patent Application Publication
(10) Pub. No.: US 2010/0325086 A1
(43) Pub. Date: Dec. 23, 2010

(54) SYSTEMS AND METHODS FOR UPDATING A DATABASE FOR PROVIDING ACCESS TO VARIOUS FILES ACROSS A NETWORK

(76) Inventors: James Skinner, Singapore (SG); Douglas Weber, Salt Lake City, UT (US)

Correspondence Address: Michael F. Krieger;Kirton & McConkie, 60 East South Temple, Suite 1800, Salt Lake City, UT, 84111, US

(21) Appl. No.: 12/652,573

(22) Filed: Jan. 5, 2010

Related U.S. Application Data
(63) Continuation-in-part of application No. 12/490,263, filed on Jun. 23, 2009.

(51) Int. Cl. G06F 17/30

(52) U.S. Cl. 707/609; 707/E17.005

(57) ABSTRACT

Systems and methods for providing access to an information stream in a format customized for a receiving device involve a network-based information storage and distribution system for receiving, storing, and distributing an information stream to a user of the information stream over a network. When a user attempts to access the media files, such as by browsing a site containing the media files or clicking on a link to the media files, a determination is made as to the type of device attempting to access the files. If the device is unknown to the system, a trial-and-error method is used to update a database of devices and what file formats, resolutions, codecs, etc., they support. Then, the selected media files are displayed or made available for download or transmission to the user's device in a format compatible with the particular device, and future access attempts by that type of device are facilitated.

### CROSS-REFERENCE TO RELATED APPLICATIONS

This application is a continuation-in-part of prior application Ser. No. 12/490,263, filed Jun. 23, 2009.

### BACKGROUND OF THE INVENTION

1. Field of the Invention

The present invention relates to providing access to various files across a newtork, and more particularly to systems and methods for updating a database for providing access to files in a format customized for a receiving device.

2. Background and Related Art

Many Internet sites, such as YouTube, Scribd, YouPublish, Posterous and other such systems provide a mechanism for users to post content, such as videos, audios, photos, or documents to the Internet. Other Internet sites, such as I-Tunes or Hulu offer various media files for users to consume online or to download for consumption locally on their computers or other consumer devices.

Users may seek to access this content from a wide variety of devices, such as personal computers or cell phones with Internet browsers installed in them. Typically, these sites convert the files that are uploaded from their various users into Flash or other commonly-recognized formats, or attempt to select a commonly-used format, such as .mp3 files for audio or .mp4 files for video, for uploading media content. YouPublish further allows download of the original unconverted file. These sites may use style sheets to ensure that information is correctly displayed on a variety of browsers, such as Internet Explorer, Safari, Firefox, Opera, etc. Some sites such as Scribd convert the files into multiple formats and give users a choice of what format to download, such as .pdf, .doc, or .txt files.

Many devices with which users may seek to access an information feed, such as cell phone devices or other portable devices like the Amazon book reader, Kindle, support only a limited range of file formats for viewing. These supported file formats are not common across devices. Some cell phones, for example, support .mp3 audio files, while others require .3gp audio files, and still others require .amr or .3g2 audio files.

The existing sites do not provide a system for users to upload content and for it to be easily viewable by a wide variety of cell phone or mobile devices that require different formats. Even systems that provide conversion of uploaded documents into multiple file formats require the user to make a selection, which is based on the user knowing what formats their devices support. Many users of cell phones and other mobile devices do not know what formats their devices support, so even after users download files, they may be unable to view the downloaded files. Existing media sites that permit users to upload their own content and attempt to choose a commonly-accepted media type encounter the same problem limiting the number and type of devices which may access and consume content from that site. Some sites, such as I-Tunes may even require the user to install software locally on their computers to access the site and make use of the sites' media files.

In today's industry, there are rapid advancements in and proliferation of devices, including mobile devices, that may be used to access files of various types. Therefore, any database or other collection of information indicative of the types of files certain devices can display and/or access quickly becomes out of date and/or lacks information regarding one or more devices that users may wish to use to access one or more files. Therefore, systems relying on such databases or collections of information are limited in their ability to correctly provide access to files over the network to such devices.

### BRIEF SUMMARY OF THE INVENTION

Implementation of the invention provides systems and methods for providing access to media files in a format customized for a receiving device, regardless of whether or not the capabilities of the receiving device are previously known by the delivering system. Implementation of the invention involves a network-based information storage and distribution system for storing and distributing the media files to users of the files over a network. In some implementations, the system receives upload of content from users and converts the file into multiple formats. In such implementations, the system includes a means of receiving upload of media files from users across a network.

When a user attempts to access the content, such as by browsing the site where the content is uploaded or posted, or by clicking on a link to the content, a determination is made as to the type of device attempting to access the content, and/or its configuration. A database of devices and what file formats, resolutions, codecs, etc., they support is then consulted to determine whether capabilities of the accessing device/configuration are known. If so, a file suitable for that device and/or configuration is selected. Then, the selected content is displayed or made available for download or transmission, such as by e-mail or instant messaging, to the user's device in a format compatible with the particular device and/or configuration, or by streaming, progressive download, or download to the user's access device in a format compatible with that particular device and/or configuration.

In instances where one or more capabilities of the accessing device/configuration are unknown to the system or systems (e.g. the device is new to the system or systems) or if a user is unable to consume a media file because the database information is inaccurate or incomplete and such knowledge is necessary for providing access to the requested content, implementations of the invention utilize one or more processes to interactively determine one or more capabilities of the accessing device/configuration. After the determination is made, a system database or other compilation of accessing device information is updated with the determined capability or capabilities, facilitating future access by the accessing device/configuration, whether by the same user or another user. The selected content is then displayed or made available for download or transmission if it was not already made available during the process or processes of determining the capabilities of the accessing device/configuration.

The system is implemented across one or more network-connected devices, such as servers, server clusters, or the like. This provides a network-connected information storage and distribution system for receiving, storing, and distributing files to a user of the files over a network. Some implementations may be configured to accept upload of files in various formats (e.g. in various formats ready for access requests by various devices) by the system operator or to accept upload from the system operator of files followed by system conversion of uploaded files into other formats to facilitate user access of the files. As content may be posted in a variety of formats, those implementations of the system that support upload of content from various users may be configured to modify or convert posts from their original format to one or more other formats to facilitate access by the user of the files and/or posts. This conversion and/or selection of what file format (whether a converted format or one of one or more original formats) is to be provided for download may be based on one or more factors, including a hardware and/or software configuration of the devices to be used to access the content and a communication speed of the connection between the system and the devices to be used to access the content. The content may be converted into various formats as it is received, or it may be converted on demand as the content is delivered to the users.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer environment for use with embodiments of the invention;

FIG. 2 shows a representative network environment for use with embodiments of the invention;

FIG. 3 shows a depiction of an embodiment of a system for providing access to media files in a format customized for a receiving device;

FIG. 4 shows an alternate depiction of an embodiment of a system for providing access to media files in a format customized for a receiving device;

FIG. 5 provides a flowchart depicting a process for providing access to media files in a format customized for a receiving device;

FIG. 6 shows a flowchart depicting a process for providing access to media files in a format customized for a receiving device while updating a database of device capabilities;

FIG. 7 shows a flowchart depicting an alternative process for providing access to media files in a format customized for a receiving device while updating a database of device capabilities; and

FIG. 8 shows a flowchart depicting a process for updating or training a database of device capabilities.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for providing access to media files in a format customized for a receiving device, regardless of whether or not the capabilities of the receiving device are previously known by the delivering system. Embodiments of the invention involve a network-based information storage and distribution system for storing and distributing the media files to users of the files over a network. In some embodiments, the system receives upload of content from users and converts the file into multiple formats. In such embodiments, the system includes a means of receiving upload of media files from users across a network.

When a user attempts to access the content, such as by browsing the site where the content is uploaded or posted, or by clicking on a link to the content, a determination is made as to the type of device attempting to access the content, a characteristic thereof, and/or the device's configuration. The determination may be made by any method, such as receiving a user access device characteristic from the user at a time of subscription to an information stream comprising multiple media files or at a time of registration to use the system, receiving a user access device characteristic from the user at a time of requesting access to a media file, detecting a user access device characteristic by pinging the user access device, detecting a user access device characteristic by pinging the user's browser, detecting a user access device characteristic from device information included in a communication sent from the user access device, detecting a user access device characteristic based on the network or IP address from which the access request is received, detecting a user access device characteristic based on an error generated in attempting to view a media file of an unsupported type, and detecting a user access device characteristic based on the carrier or communications provider from which the access request is received.

A database of devices and what file formats, resolutions, codecs, etc., they support is then consulted to determine whether capabilities of the accessing device/configuration are known. If so, a file suitable for that device and/or configuration is selected. Then, the selected content is displayed or made available for download or transmission, such as by e-mail or instant messaging, to the user's device in a format compatible with the particular device and/or configuration, or by streaming, progressive download, or download to the user's access device in a format compatible with that particular device and/or configuration.

In instances where one or more capabilities of the accessing device/configuration are unknown to the system or systems (e.g. the device is new to the system or systems) or if a user is unable to consume a media file because the database information is inaccurate or incomplete and such knowledge is necessary for providing access to the requested content, implementations of the invention utilize one or more processes to interactively determine one or more capabilities of the accessing device/configuration. After the determination is made, a system database or other compilation of accessing device information is updated with the determined capability or capabilities, facilitating future access by the accessing device/configuration, whether by the same user or another user. The selected content is then displayed or made available for download or transmission if it was not already made available during the process or processes of determining the capabilities of the accessing device/configuration.

The system is embodied across one or more network-connected devices, such as servers, server clusters, or the like. This provides a network-connected information storage and distribution system for receiving, storing, and distributing files to a user of the files over a network. Some embodiments may be configured to accept upload of files in various formats (e.g. in various formats ready for access requests by various devices) by the system operator or to accept upload from the system operator of files followed by system conversion of uploaded files into other formats to facilitate user access of the files. As content may be posted in a variety of formats, those embodiments of the system that support upload of content from various users may be configured to modify or convert posts from their original format to one or more other formats to facilitate access by the user of the files and/or posts. This conversion and/or selection of what file format (whether converted or one of one or more original formats) is to be provided for download may be based on one or more factors, including a hardware and/or software configuration of the devices to be used to access the content and a communication speed of the connection between the system and the devices to be used to access the content. The content may be converted into various formats as it is received, or it may be converted on demand as the content is delivered to the users.

Although a portion of the discussion provided herein describes embodiments where an e-mail is used to facilitate access to files or other content, it should be understood that embodiments of the invention embrace many types of communications facilitating access to files or content, including files or content delivered via a browser. For example, embodiments of the invention enable files and content to be delivered via links provided using short message service (SMS) messages, multimedia message service (MMS) messages, and text messages (texts) or any other form of communication or notification. Additionally, where e-mail addresses are referred to herein, it should be understood that any unique user identifier and/or other information may be used to identify a user and direct notifications to that user. As one example only, the user's cell phone number may be used as an identifier and notifications may be sent to the user's cell phone using the cell phone number. As new communications methods emerge, it is anticipated that embodiments of the invention can be adapted to such communication methods.

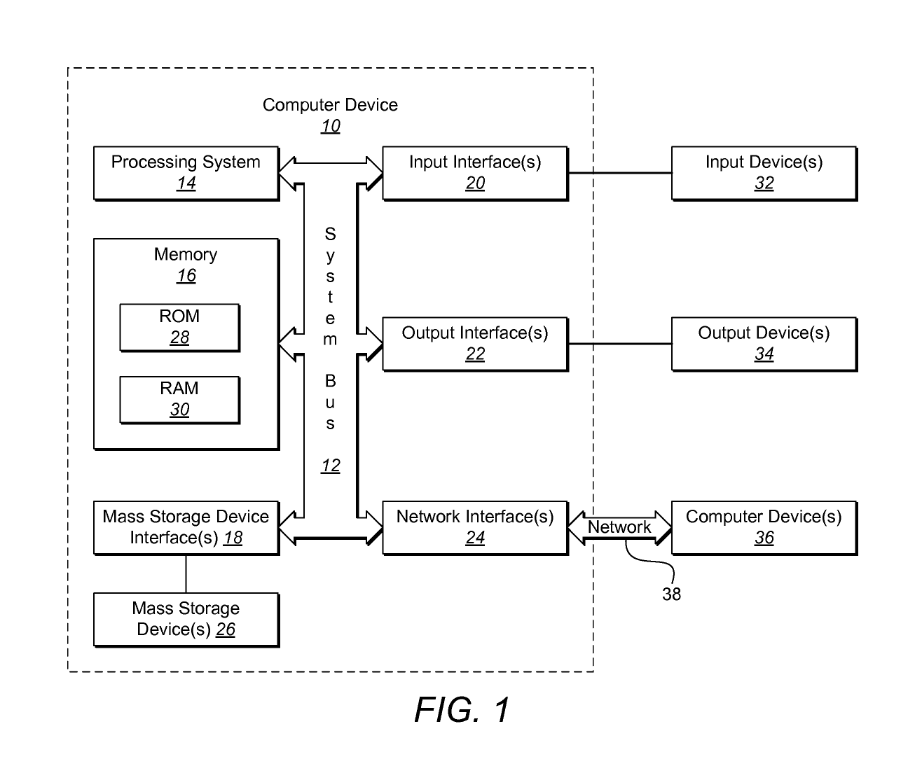

As embodiments of the invention embrace the use of network-connected consumer electronic devices and various network-connected computer devices, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer, or a consumer electronic device. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash memory drives, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

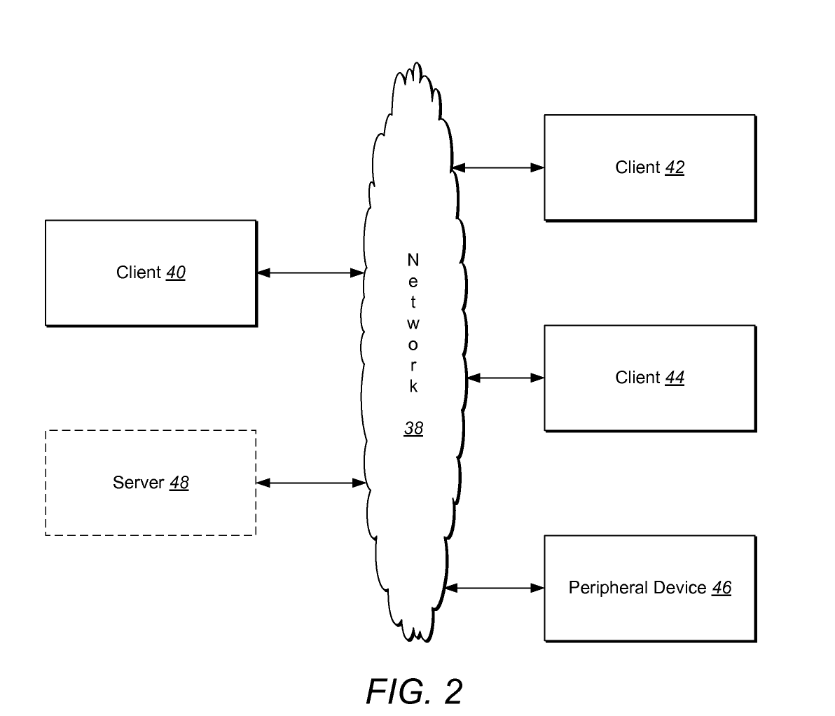

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Each of the clients 40, 42, or 44, or client computer devices can be any of a wide range of computer and consumer devices configured for connection to the network 38. Non-limiting examples of such devices include cell phones, smart phones, netbooks, laptops, tablet computers, personal/desktop computers running any of a variety of operating systems, workstations, personal data assistants (PDAs), electronic readers, wireless reading devices, e-book readers, or any other current or future computer device configured for at least intermittent access to the network 38.

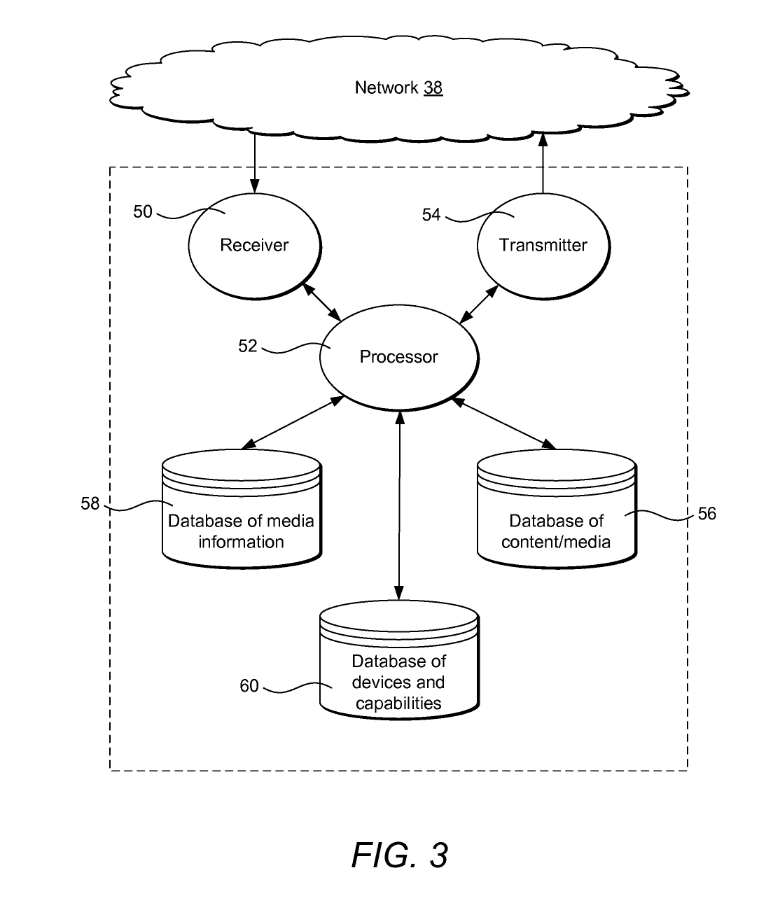

FIG. 3 shows one possible configuration of a network-connected system for storing and distributing media files to users of the files over a network. The system is connected to the network 38 and may be implemented across one or more of a variety of computer devices, including servers and the like. The system includes a receiver 50. The receiver 50 receives requests in any format over the network 38 from users. The requests can include requests to access content such as a media file stored on the system. The requests can take one of several formats, including an e-mail, a text message, a SMS message, a MMS message, a request received from a website supported by the system, selection of a link within a webpage, e-mail or other notification, a request provided by an application programming interface (API), or any other network-delivered request. Other types of requests that may be received by the receiver 50 include requests to post new media files or information on the system for access, as will be discussed further below, and any other request to interact with the system.

Regardless of the type of request, it is passed to a processor 52, which identifies the substance of the request by reference to information contained in the request. Where the request is a request for access to a media file stored on the system, the processor 52 identifies the media file on the system and delivers the media file to a transmitter 54 for transmission of the media file to the requesting user. If a password is required to access a particular media file, the processor 52 determines whether the password has been included in the request or requires the requesting user to submit the password before providing access to the requested media file. Where the request is other than a request for access to a media file, the processor 52 handles the request as appropriate.

The system stores media files in a database of content or media (“media database 56”), that may store a plurality of media files in a plurality of formats. The processor 52 may identify the media files stored in the media database 56 in a variety of manners. For example, the processor 52 may identify the media files by direct reference to the media database 56 to search for the media files as those files are requested. Alternatively, the processor may reference an index or a database of media information (“media information database 58”) storing information regarding the media files, their storage location and/or filename, etc. on the media database 56. Other methods and systems for identifying media files for delivery upon request are embraced by embodiments of the invention, and the described mechanisms are therefore merely illustrative, and not limiting.

Because of the wide variety of access devices (e.g. computer devices, consumer electronic devices such as electronic readers, cell phones, smart phones and the like) that may be used to seek access to the media files through the system, the system includes the capability to deliver access to the media files in formats compatible with the access devices. Accordingly, the system includes a database of access devices and capabilities (“access device characteristics database 60”). The access device characteristics database 60 stores information relating to characteristics of various access devices that are used by the system to determine how the media files should be formatted to facilitate access to the media files. Such information may include a type of the user access device, a manufacturer of the user access device, a model of the user access device, a hardware configuration of the user access device, a software configuration of the user access device, a combined hardware and software configuration of the user access device, and/or file formats, resolutions, and/or codecs supported by the user access device. Such information may be stored for any or all of a variety of user access devices, such as a cell phone, a smart phone, a netbook, a laptop computer, a tablet computer, a desktop computer, a workstation, a personal digital assistant (PDA), an electronic reader, a wireless reading device, and the like, whether currently utilized or later developed.

The processor 52 utilizes the access device characteristics database 60 to determine which media file to provide access to upon a request for a media file and/or to determine how a media file should be converted so as to facilitate access to the media file for the requesting user's access device. When media files are loaded into the system (either by a posting user or by a system administrator), they may be stored in their original format in which they were received, and/or they may optionally be converted into one or more other formats and stored in the other format or formats. For example, a media file uploaded to the system may be uploaded in a non-standard format. The system or some component thereof (e.g. the processor 52) may convert such a file into one or more more-standard formats to facilitate distribution and access to the media file, and the media file may be stored in such format(s) in the media database 56 in addition to or in lieu of the original format. The format or formats in which the media file is available may be stored in the media information database 58. Even when the media file is converted into one or more more-standard formats, the converted formats may not be compatible with a particular access device, so the system permits further conversions to occur to provide the media file to a compatible format. Such further conversions may be performed at the time of file upload, at the time of a file access request, or at an intermediate time.

Access to the file in the compatible format may be provided using many different methods. In some instances, an e-mail sent by the transmitter 54 includes a link to access the media file, or a link to a page having additional links to the media file or one or more components thereof (e.g. direct linking and/or indirect linking). In other instances, the media file itself is contained in the body of an e-mail or as an attachment thereto. Regardless of how content is delivered to the user (as a link within the e-mail or delivered with the e-mail itself, or by some other mechanism), the media file is provided in a format that facilitates access by the user. The provided format may also take into account communication speeds between the system and the users' access devices. For example, many cell phones have varying communications rates, and the communications rate of an individual cell phone may vary depending on a cell phone user's location within a cell phone network. If a video is originally posted in lossless high definition (HD) format, it may be undesirable to deliver the video in that format to a user's cell phone over a slow network. If, however, the video is first converted to a lower resolution and a compressed format, the cell phone may be better able to receive and display the video in a meaningful way to the user. For example, the resolution capable of being displayed on the device may be determined and a resolution smaller to or equal to this resolution is selected.

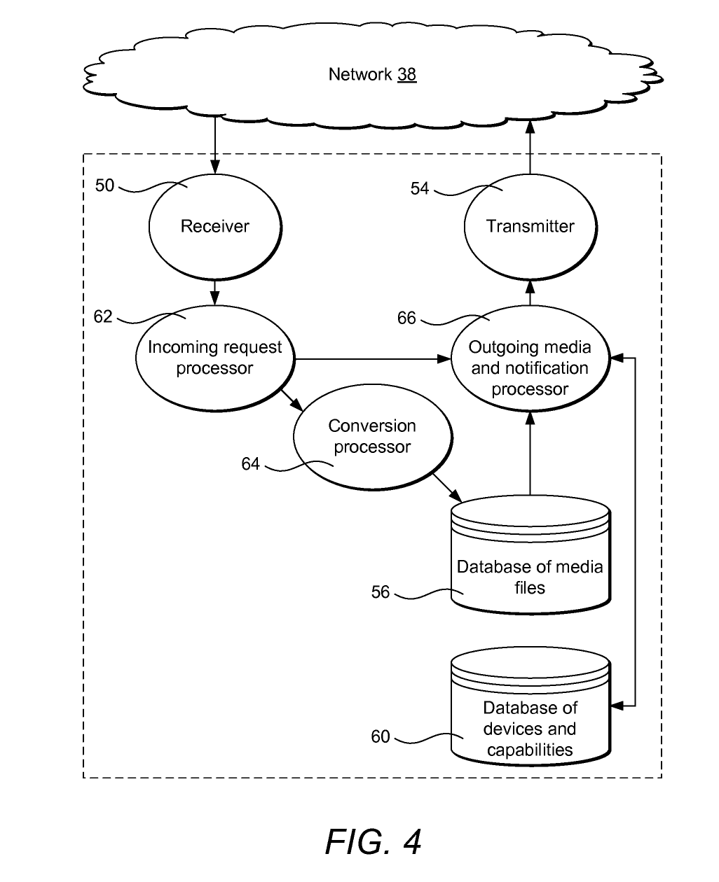

FIG. 4 displays an alternate embodiment or depiction of a network-connected system for storing and distributing media files to users of the files over a network. In this embodiment, the system includes an incoming request processor 62 that handles incoming requests received by the receiver 50. The incoming requests may include requests to subscribe to a content stream containing one or more media files, requests to unsubscribe to a content stream, requests from content-posting users to post content (e.g. media files), requests to cancel an account (either from a user or a content-posting user), requests for support, reports of abuse, or any other type of incoming request. The incoming request processor 62 processes the requests and responds to the requests appropriately, executing the appropriate action according to the type of the incoming request.

The receiver 50 and the incoming request processor 62 receive the incoming requests using any of a variety of formats. E-mails may be received using the Internet message access protocol (IMAP) or any other protocol. Although many requests may be received by e-mail, other requests may be received and handled by the incoming request processor 62 by other mechanisms, including requests received from a web site interface (e.g. a form post or a link click to perform the request), and requests received through an application programming interface (API) such as of a third-party application sending the request. Other requests may be received by SMS or MMS or by any other system. In at least some embodiments, any type of request can be received using any of the possible request avenues, whether currently used or developed in the future.

If the incoming request is a post request containing content, the content may be passed to a conversion processor 64. The conversion processor 64 serves to convert or modify the content in a way that facilitates user access. Although one conversion processor 64 is illustrated, it should be understood that multiple or many conversion processors 64 may be used to convert files of various types and formats (e.g. different conversion processors 64 may be used for images as opposed to videos, images of one file type as opposed to another type, etc.). The conversion processor 64 converts recognized incoming media into one or more of a variety of standard and targeted encodings, including resolutions, codecs, and compression settings. For example, a Word document may be converted to a PDF document or another targeted format. A high-resolution QuickTime movie may be converted into a lower resolution movie and/or to another format, such as .mp4 or .3gp. Such conversions facilitate an optimal consumption experience for the users of the media files, by making access to the media files either possible in the first place or simply more convenient.

The conversion processor 64 may provide the converted media files to the media database 56, where the converted media files may be accessed by an outgoing media and notification processor 66 for inclusion in notifications to be sent over the network 38 by the transmitter 60. Alternatively, the converted media files may be accessed by the user selecting a link on a website or in a notification as described above.

As the system is designed to facilitate user access to media files, the system may be configured to determine hardware and/or software configurations or modes of the user access device or to receive a notification from the user of such configurations or modes. In some embodiments, the system can detect the hardware and/or software configurations or modes, such as by using a user agent to detect a browser header. Another manner of detecting the hardware and/or software configurations or modes is by detecting device information included in e-mails sent by the user device, such as header information. Other manners of detecting a device characteristic of the hardware and/or software configuration include: receiving the user access device characteristic from the user at a time of subscription to an information stream comprising multiple media files or at a time of registration to use the system, receiving the user access device characteristic from the user at a time of requesting access to a media file, detecting the user access device characteristic by pinging the user access device, detecting the user access device characteristic by pinging the user's browser, detecting the user access device characteristic from device information included in a communication sent from the user access device, detecting the user access device characteristic based on the network or IP address from which the access request is received, detecting the user access device characteristic based on an error generated in attempting to view a media file of an unsupported type, and detecting the user access device characteristic based on the carrier or communications provider from which the access request is received.

By detecting the hardware and/or software configurations or modes, the system can deliver a file format that is supported for viewing on the user access device. To facilitate this delivery, the system maintains the access device characteristics database 60. The access device characteristics database 60 contains a list of devices on which posted media files could be consumed and associated device characteristics. This database includes information that improves the user's media files consumption experience, such as any of determining the proper encodings, file types, resolutions, compression codecs, etc. with which to present a selected file to the user access device.

When the user accesses media files or when the system attaches media files to a notification, the system (such as through the outgoing media and notification processor 66) determines the applicable hardware and/or software configurations or modes, references the access device characteristics database 60, and provides access to the media files in the media database 56 in a format determined to enhance and facilitate user access through the access device. This determination may also or alternatively take into account a connection or communication speed between the system and the access device, such that one or more media files is timely delivered regardless of the communication speed. While any of a variety of factors may be considered when delivering access to the media files, non-limiting examples of some factors for consideration include: the make and model of the access device, information about how various user access devices are configured at the time of their manufacture or sale, information about the file formats, resolutions, or codecs that the manufacturer claims the device supports, information about the file formats that are supported as standard by a given carrier or communications provider and the access devices that are sold to users of that carrier or communications provider, the operating system of the device, access programs available on the device, the data transfer speed, the native screen resolution of the device, the browser being used, etc. Thus the media files may be delivered in a manner that is more convenient and enjoyable to the user.

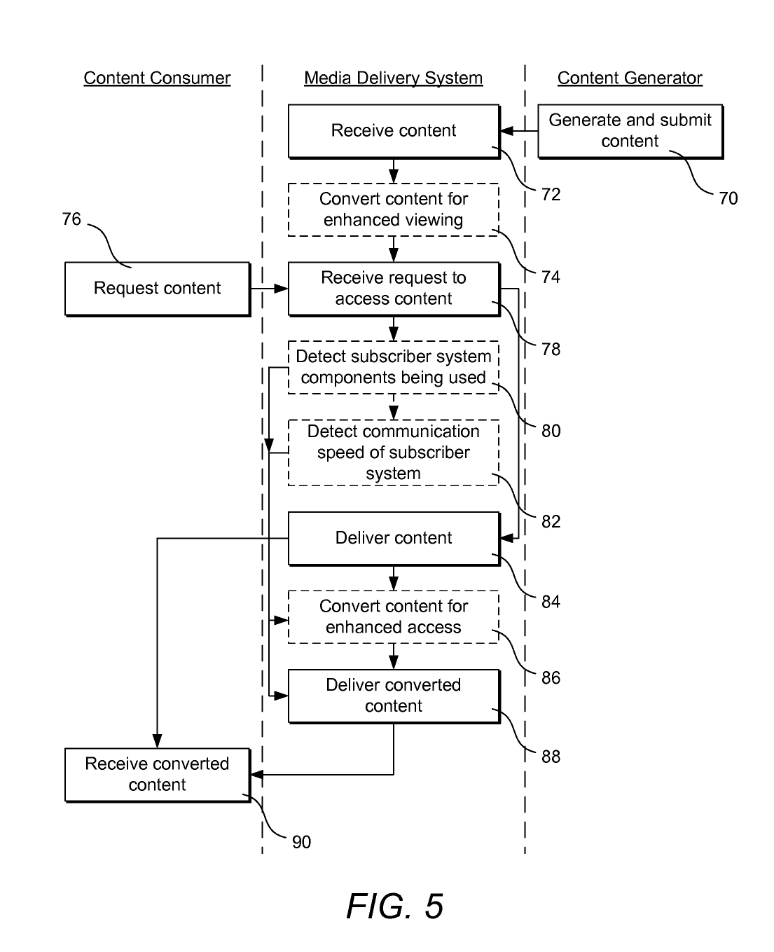

In some instances, media files may be converted into a variety of formats, encodings, resolutions, and the like, immediately upon receipt. In other instances, it may be desirable to convert or modify media files as needed, either at the time of sending notifications to users or at the time users attempt to access the media files. In still other instances, a hybrid approach may be used, where the media files is converted or partially converted into some formats, resolutions, and the like, immediately upon receipt and into other formats, resolutions, and the like, at a later time. Each time of conversion has certain advantages. Early conversion facilitates maximum speed of delivery to users upon request. Later conversion may avoid conversion into unneeded formats and may save storage space. Thus, different instances and different embodiments may opt for conversion at different times as is illustrated in the flow charts of FIG. 5.

FIG. 5 depicts an illustrative process for delivery of content (e.g. one or more media files) posted by a content generator (or a system administrator) on a system for storage and delivery of a variety of media files over a network. Execution begins at step 70, where the content generator generates and submits content. The system for storage and delivery of a variety of media files receives the content at step 72. The system may optionally convert content for enhanced viewing at step 74, as described above. Regardless of whether content is converted at step 74, execution proceeds to step 76, where a user requests to access the content, and the system receives the request to access the content at step 78.

The system may optionally detect or determine the user system components (e.g. hardware and/or software configuration or mode) being used at step 80 and may alternatively or additionally detect or determine a communication speed of the user system at step 82. If, however, no detection or determination occurs, the content is delivered at step 84.

If one or more of the detection/determining steps 80, 82 occurs, execution may proceed to either of steps 86 or 88, depending on whether the updated content is already in a format configured for an enhanced user experience. If the content either already is stored in a desired format (e.g. was received in that format at step 72) or has already been converted to a desired format at step 74, the content is delivered at step 88. If, however, the content should be converted to enhance the user experience, it is first converted at step 86 before being delivered by the system at step 88. Regardless of whether or when any conversion occurred, the content is received by the user at step 90 and is consumed by the user using the user's access device, whatever it may be.

As discussed above, the system is configured to detect hardware and/or software being used on the accessing device when the accessing device is used by the user to attempt to access content via a link in some embodiments. In some instances, however, the device hardware and/or software configuration or mode is one not included in the access device characteristics database 60. If the device hardware and/or software configuration or mode is not included in the access device characteristics database 60, the system stores and/or outputs the detected data on the device and/or software making the request to access content.

Such new device and configuration information can be used in various ways. In one example, the information is used to look up, research, or otherwise determine the capabilities of the device and its software so the system can provide content to the device in a format designed to enhance the user's experience. In another example, it may be determined that the number of users having configurations similar to those detected and added to the system do not merit supporting or fully supporting the detected configuration or mode, in which case partial support may be provided or the system may track the number of users having that configuration until that number justifies the resources to support or fully support the detected configuration or mode. In this way, the system can dynamically adjust to and support new devices and capabilities to enhance users' consumption experiences.

In instances where a device and/or configuration used by the requesting user is a new device or one whose characteristics and capabilities are not stored in the access device characteristics database 60, it is desirable to provide the user with access to the requested file. It may also be desirable to update the access device characteristics database 60 so that future requests by the user using that access device/configuration and/or requests by other users using the same or similar access devices/configurations can be fulfilled by the system. Therefore, embodiments of the invention provide one or more methods for determining one or more file types that may be displayed, played, or otherwise accessed by a user's access device, or for determining any other information regarding the user's access device/configuration that may be helpful in providing access to files over the network. The system then updates the access device characteristics database 60 with information regarding the user's access device/configuration. Thus, embodiments of the invention provide for updating, including continuous updating of the access device characteristics database 60 with information regarding various user access devices as the user access devices are used to attempt to access files from the system.

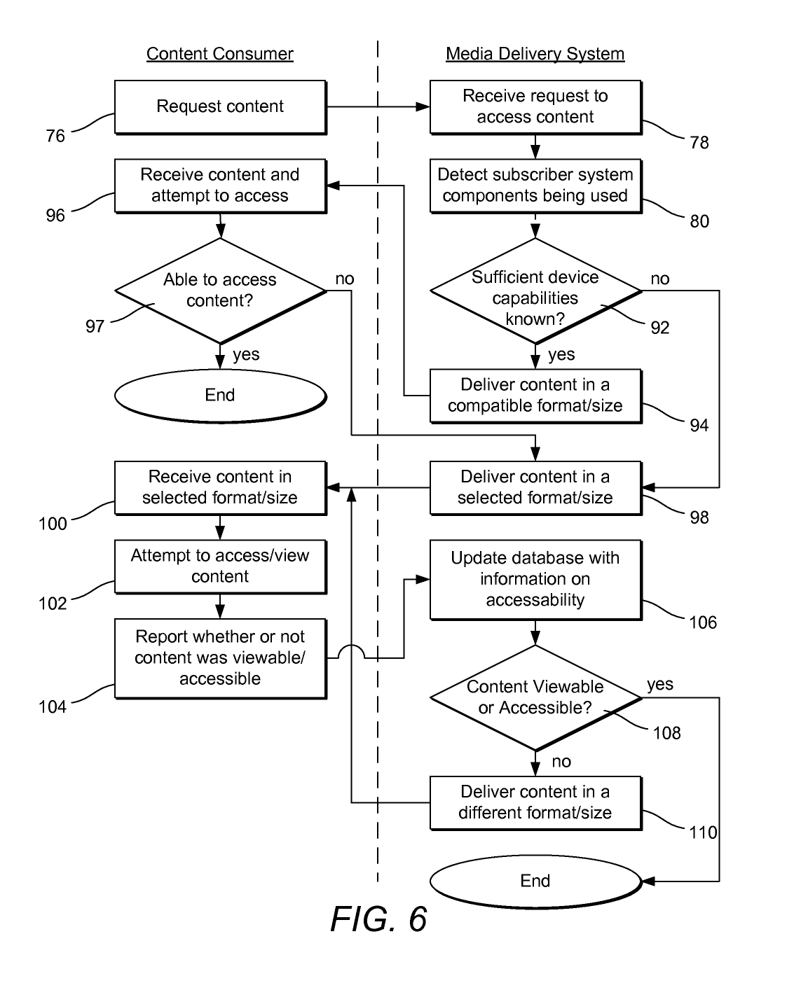

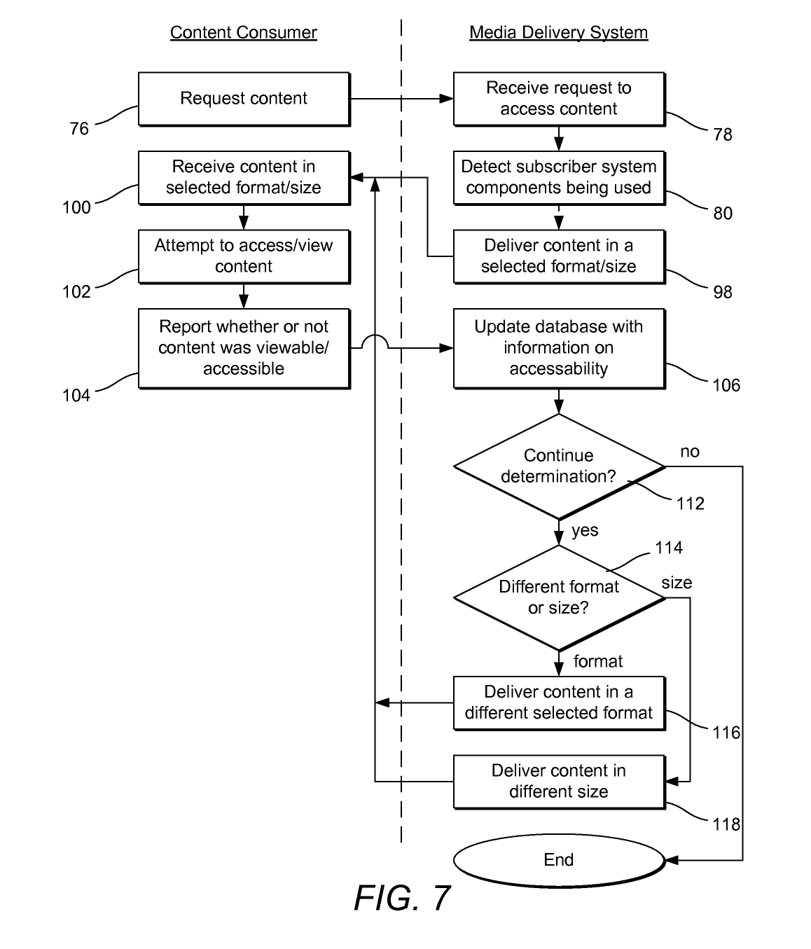

FIG. 6 illustrates a flow chart illustrative of methods according to such embodiments. It should be understood that although some of the steps illustrated in FIG. 5 are not specifically illustrated in FIG. 6 (or FIG. 7), some of the steps not so illustrated may be incorporated into the processes illustrated in later Figures, where appropriate. In the flow chart of FIG. 6, execution begins at step 76, where a would-be content consumer requests content from the system. As discussed above, the request may be generated and transmitted to the system in any of a variety of manners. The request is received by the system at step 78, and is handled as discussed above.

At step 80, the system determines or detects the type of user access device (e.g. a particular make and model of cell phone, etc.) by which the user is attempting to view or otherwise access the requested file. As discussed above, the type of user access device may be determined by any mechanism method now known or later developed, and may include a determination as to hardware and/or software of the user access device. Example manners for determining the type of user access device include detecting the device's user agent, detecting a browser header, detecting device information included in an e-mail sent by the user device, receiving an indication of the type of user access device from the user in the request or in an earlier communication, pinging the user access device or a browser thereof, basing a determination on a network or IP address from which the request is received, basing the determination on an error message, basing the determination on a carrier or communications provider from which the access request is received, and the like. As discussed above, the determination may also take into account a communication speed (overall or current) of the connection of the user access device.

At decision block 92, a determination is made as to whether sufficient device capabilities and/or characteristics are known about the user access device to allow the system to properly respond to the request and to provide access to the requested file. If so, execution proceeds to step 94, where the system delivers the content in a compatible format and size and in the manner specified by the request and/or allowed by the system. At step 96, the content consumer receives the content and attempts to view/access it. At decision block 97, a determination is made as to whether the content consumer was able to access the content. If yes, execution ends. If not, for whatever reason, execution proceeds as in the event the system has insufficient information regarding the device capabilities and/or characteristics to allow the system to properly respond to the request, and proceeds to step 98.

There are various reasons why a user may be unable to view or otherwise access content even when information regarding the user's access device may be located in the access device characteristics database 60. In one example, the information in the database may be outdated or incorrect. In another example, something about the user's access device may have changed (hardware, firmware, software, updates, etc.). Such changes may lead to incompatibility with certain file types. As another example, different versions of a particular device may be available and may have different capabilities, and the access device characteristics database 60 may not have this information. In another example, the user's access device may have a problem or fault causing a previously-unknown incompatibility.

In the event the system has insufficient information to properly provide the user with access to the file, if the user is unable to access content, or if the user opts to begin a routine for discovering device capabilities for any reason, execution proceeds to (or may begin at) step 98, where the system delivers some content in a selected format and size to the user access device. The initially-selected format and size may be selected/determined using any of a wide variety of factors. As one example, the initially-selected format and size may be selected or determined based on formats/sizes that tend to be most commonly accessible or most commonly used. This example utilizes a theory that a device will tend to be compatible with the most commonly-used file types and sizes.

As another example, the system utilizes what information is known about the user access device to select a file type and/or size believed to most likely be compatible with the device. This selection need not necessarily be the most common file type. In one situation, the system might know that the user access device is made by Manufacturer X. The system might refer to the access device characteristics database 60 and determine that most devices by Manufacturer X are compatible with a certain file type and size, even if other manufacturers tend not to primarily utilize that file type. The system might therefore select the file type most commonly supported by Manufacturer X devices. In another situation, the system might be aware of the manufacturer and model number or name of the user's access device. By referring to the access device characteristics database 60, the system might locate a device by the same manufacturer having a similar model number or name, and might attempt first to deliver a file type and size compatible with the apparently-similar device. In still another situation, the system might know a carrier or service provider associated with the device (e.g., for a cell phone, which carrier/network the user's access device is using), and might refer to the access device characteristics database 60 to determine file types and sizes that tend to be compatible with devices utilizing that carrier or service provider. The system then might first attempt to deliver content in a format/size commonly acceptable for devices utilizing that carrier or service provider.

Still other methods may be used to determine an initial format and/or size with which to first attempt to deliver content to the user access device. Such methods include random approaches and quasi-random approaches, as well as hybrid approaches of any of the above-discussed and/or other approaches not specifically discussed herein. For visual file types such as videos, pictures/photos/graphics, and the like, the system may initially default or may tend to initially provide the content in a lower resolution, as lower resolutions tend to be compatible with a broader range of user access devices and tend to be accessible even when larger-resolution files are also compatible with the user access device. The system may also select lower-resolution files in situations where the system is able to determine that a communications speed of the user access device (whether a current communications speed imposed by the user's connectivity to the network or a maximum communications speed of the device) is a slower connection speed.

Regardless of the file format/size selected for delivery at step 98, the delivered content may or may not be the content originally requested by the content consumer. In some instances, the system may instead utilize sample content until one or more of the capabilities of the user access device have been determined. It may be desirable to utilize sample content instead of the originally-requested content for a variety of reasons. For example, the comparative size (e.g. file size) of the requested content in comparison with the sample content may be quite large. Thus, it may be beneficial to avoid sending large amounts of potentially-incompatible content to the user access device until it has been determined that the user access device can correctly access the content. As another example, as discussed above, not all content may be stored on the system in all possible formats and sizes/resolutions. Thus, in some instances, the system may need to convert the requested content into a format other than a stored or otherwise-available format. Rather than waste system resources converting the requested content into a possibly-unnecessary and possibly-incompatible format and/or size (and possibly into several or many such formats and/or sizes), the system may instead store and/or convert sample content into the various formats and sizes. It is relatively trivial to convert and/or store a limited set of sample content into a wide variety of formats and sizes. These formats and sizes of sample content may be used to determine the proper format and size for the user access device as discussed herein, and then the desired content is converted, if necessary, and delivered to the user access device.

Sample content need not be used in some instances and embodiments. For example, where the requested content is of a relatively small size, where the requested content is readily available in a variety of formats/sizes and/or in the format/size to be delivered, and/or where sufficient system resources are available to attend to the conversion of the content into the selected format/size to be delivered, the requested content may be used to discover what formats/sizes the user access device is able to display/access. Some users expect or prefer that the originally-requested content be delivered as soon as possible, and such expectations may be better met by utilizing the originally-requested content in the trial format/size at step 98. In some embodiments, the content consumer may be presented with an option to select whether the determination should proceed using the originally-requested content or using sample content, such as with a message along the lines of:

“To deliver the requested file, we need to determine what file types are compatible with your device. This process usually goes faster with a short sample file, but we can also proceed with your requested file. How would you like us to proceed?”

Regardless of the file format and size selected for delivery at step 98 and the methods used to select the selected format and size, the content is received by the content consumer at step 100. The user and/or the user's access device then attempts to view or otherwise access the content at step 102. At step 104, the user or the user's access device reports whether or not the content was viewable or otherwise properly accessible. In one embodiment, the user is presented with an input or link (such as a “trouble” button) to indicate whether the user was able to view or access the provided content. In another embodiment, the user access device may automatically or semi-automatically generate an error message to the media delivery system indicating the file was not compatible. Where the originally-requested content was delivered, the system may interpret a failure to select an input/link or a failure to receive an error message as an indication that the user access device was compatible with and was able to allow the user to view/access the content.

At step 106, the system utilizes any feedback information received (or the lack thereof) to determine whether the selected file format and/or size was compatible (or was possibly compatible) with the user access device and updates the access device characteristics database 60 accordingly for future reference. The system also makes a determination at decision block 108 as to whether the delivered content was viewable or otherwise accessible. If yes, and if the delivered content was the originally-requested content, execution ends, as shown in the flow chart of FIG. 6. If yes, but the delivered content was not the originally-requested content, the system then may provide the user with the requested content in the format/size determined to be compatible (this step is not shown in FIG. 6). If necessary, the requested content may be converted for delivery as discussed above, or a previously-converted copy may be selected from storage and delivered.

If, however, the delivered content was not viewable or otherwise accessible by the user access device, execution proceeds to step 110, where content (either sample content or the originally-requested content, as discussed above) is delivered to the user access device in a different format or size. Thereafter, execution loops back to step 100 until the content is found accessible or until all available formats/sizes have been attempted without success.

By this process, or some variation thereof, the access device characteristics database 60 may be updated with information regarding any of a variety of user access devices not previously in the access device characteristics database 60. Additionally, the access device characteristics database 60 may be further updated with respect to certain information not previously in the access device characteristics database 60 for a certain device. For example, information may be located in the access device characteristics database 60 for a certain user access device for audio files, but not for video files. This information may have been manually entered previously or may have been discovered according to a process similar to that shown in FIG. 6. In such an instance, a process similar to that shown in FIG. 6 may be utilized when a video file is requested, and the access device characteristics database 60 may be updated accordingly. Similarly, a process similar to that shown in FIG. 6 may be utilized for each type of file (e.g. audio files, video files, picture files, textual files, etc.) sought to be accessed for the first time by a certain type/configuration of user access device. The access device characteristics database 60 may also be updated with respect to information that may have changed with respect to a particular device, as discussed above.

Although the process illustrated in FIG. 6 illustrates the access device characteristics database 60 being updated after each trial format/size, whether successful or not, it should be understood that the information stored in the access device characteristics database 60 may be varied from embodiment to embodiment. For example, in one embodiment, the access device characteristics database 60 may primarily store information regarding compatible file types/sizes. In such an example, the access device characteristics database 60 might only be updated after successful attempts to access/view the content. In another embodiment, the access device characteristics database 60 may only store incompatible formats/sizes as long as one or more compatible formats/sizes are not known, after which the incompatible formats/sizes information may be discarded. Thus, the process illustrated in FIG. 6 is merely illustrative of one sample process that may be undertaken in accordance with the various embodiments of the invention.

FIG. 7 illustrates aspects of alternative or additional steps that may be taken in addition to those illustrated in FIG. 6. Therefore, although not all steps shown in FIG. 6 are specifically shown in FIG. 7, it should be understood that those steps of FIG. 6 that are applicable to FIG. 7 may be undertaken in the process illustrated in FIG. 7. In the process of FIG. 7, the content consumer requests content at step 76, and the system receives the request at step 78. The system detects or otherwise determines information regarding the user's access device/configuration at step 80 and delivers content in a selected experimental format/size at step 98. As discussed above, the selected format/size may be selected using any of a variety of methods or mechanisms, and the delivered content may be the requested content or sample content. The content is received at step 100, access is attempted at step 102, and a report is made as to whether the attempt was successful at step 104, as discussed above with respect to FIG. 6.

In the embodiment of FIG. 7, after the access device characteristics database 60 is updated at step 106, execution proceeds to decision block 112, where a determination is made as to whether to continue attempting delivery of different file types or sizes. If not, execution ends (with delivery of the requested content in a compatible format/size, if not yet completed), as discussed with respect to FIG. 6. In one example, the requesting user may request an end to the discovery process, either because access has been successful or the user has tired of the attempt for at least the time being. In another example, all necessary information regarding the user access device has been determined. In still another example, all possible file formats/sizes have been attempted.

In some instances, even if file viewing/access has been successful, the user and/or system may wish to continue attempting to learn more about the user access device. For example, it may be desirable to learn if other file formats are supported other than the type first determined to be successful. Thus, even if playing of one video format (e.g. .mp4) was successful, it may still be possible to play other video formats (e.g. QuickTime). Learning the full set of compatible file types for a particular device may allow the system to avoid unnecessary conversions of requested content at a later date. Similarly, if the user is willing, it may be desirable to learn about the user access device's support of other file types (e.g. learning about support of audio file types and picture file types, even though the originally-requested content was a video). Additionally, it may be advantageous to determine a maximum resolution of a file type that the user device can support. Thus, if the system originally attempted delivery of a very low resolution video, it may be desirable to continue the process to determine if the user access device is capable of displaying higher resolution videos to improve the user's viewing experience.

Thus, if it is determined to continue at decision block 112, execution proceeds to decision block 114, where it is determined whether to proceed with a different format or with a different size. It should also be understood that both a format and size may be simultaneously varied. If a different format is selected, execution proceeds to step 116, where the content is delivered in a different format. If a different size is selected, execution proceeds to step 118, were the content is delivered in a different size. Execution then loops back to step 100 for attempted viewing/access by the content consumer, and reporting on success or failure of the attempted access. The process may loop back in this fashion until all desired information is obtained, such as a maximum resolution that the user access device can support, a maximum file size that the user access device supports, etc. In one example, the process first proceeds through a variety of file formats until a supported file format/type is located, and then proceeds through progressively larger resolutions/file sizes until a failure occurs, showing that files of a size larger than the last successful file cannot be viewed. The access device characteristics database 60 is updated accordingly.

In instances where viewing or other access to a file is desired that might result in attempted access to files larger than those determined to be supported by a particular user access device, the system may utilize one or more methods to facilitate access by such devices. In one embodiment, the system is configured to convert files into lower resolutions to facilitate access. In another embodiment, the system is configured to convert the content into multiple smaller files or portions (e.g. dividing a video clip into multiple smaller video clips that can be downloaded or otherwise accessed individually) for download/access and/or for storage in the media database 56 for later download/access.

One or more processes in accordance with or similar to those illustrated in FIGS. 6 and 7 may be provided to all users of the system, or such processes may only be provide when a successful viewing type is not indicated in the access device characteristics database 60. Alternatively, such processes may be provided in instances where a user indicates that he or she has had difficulty viewing or otherwise accessing one or more files delivered by the system.

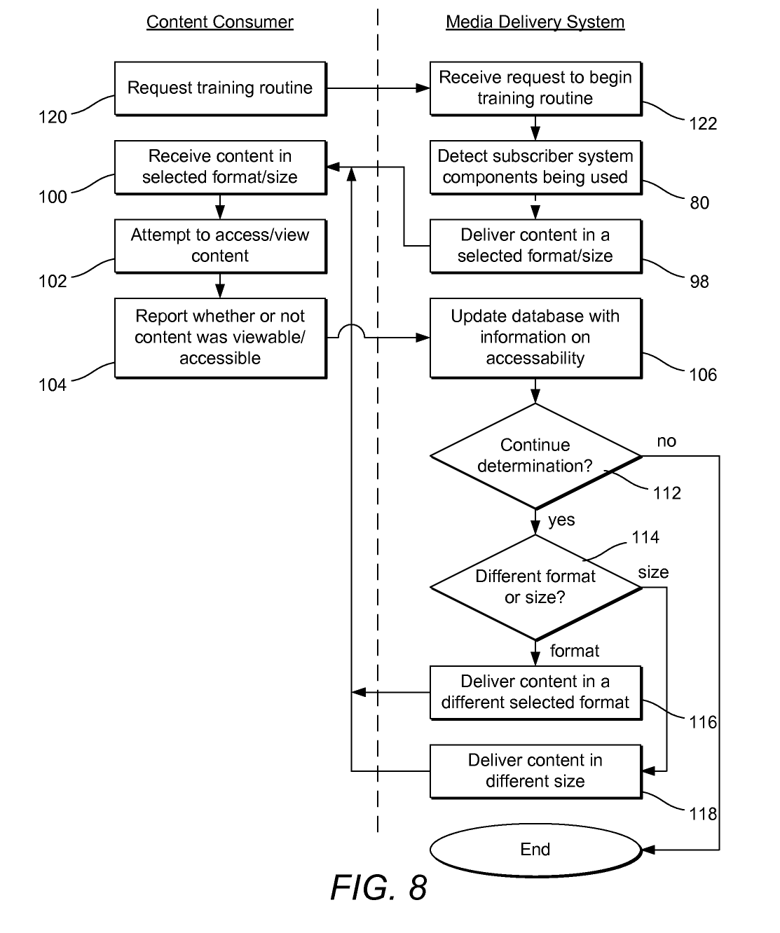

Processes for updating the information in the access device characteristics database 60 (effectively “training” the access device characteristics database 60) may thus be instituted in a wide variety of circumstances. In addition to the examples discussed above, training the access device characteristics database 60 may occur upon a first visit to a site hosting files for access or when a user selects a training tool at any time for whatever reason (e.g. the user decides he or she has time to perform the training routine on a subsequent visit, the user encounters difficulty in viewing a file after a device update or the like, or for any other reason). Thus, in some embodiments or instances, the process of updating or training the access device characteristics database 60 does not begin with a request to access a media file. FIG. 8 illustrates one example of such a process.

The process begins at step 120, where a content consumer initiates a request or action of some sort that is to trigger a software routine for updating/training the access device characteristics database 60. As discussed, this may be by accessing a site for the first time, by selecting a link or button indicative of a desire to determine what file types/sizes are compatible with an access device, by selecting a link or button indicating trouble in viewing a particular file, or any other action triggering the software routine. At step 122, the request or other action triggering the updating/training routine is received by the system.

Once the training routine begins, it is substantially similar to the process illustrated in FIG. 7, and thus the corresponding discussion with respect to the steps shown in FIG. 7 (and in FIG. 6, where applicable) applies. Execution proceeds to step 80, where a determination is made (if it has not been made previously) as to the user's access device or information regarding the device. Content (e.g. a file in a first size and format) is selected for delivery, such as according to any of a variety of algorithms (e.g. common formats, formats commonly supported by a particular provider, etc.), and is delivered by the system to the user's access device. The user receives the content at step 100 and attempts to access or view the content at step 102. The user is then provided with an opportunity to report whether the content was accessible at step 104. One common mechanism for this has been discussed above, namely the provision of a link or button for indicating the ability or inability to access the content. If a selection of a link or button indicative of an inability to access the content is made, it in effect is a further request for starting (in this case continuing) the routine for updating/training the access device characteristics database 60.

The access device characteristics database 60 is updated with information regarding the success or failure to access the content at step 106, and execution proceeds to decision block 112, where a determination is made as to whether to continue the routine for updating/training the access device characteristics database 60. If the routine is to continue, execution proceeds to decision block 114 for a determination as to whether a different size and/or format is to be provided, and a different size and/or format is provided at one or both of steps 116 and 118, whereupon execution loops back to step 100 for further attempts to access the file at the consumer access device, until a successful attempt is achieved or all available formats/sizes have been attempted.

Thus the media files may be delivered in a manner that is more convenient and enjoyable to the user, regardless of whether sufficient information to deliver the media files is originally known by the system. Systems and methods in accordance with embodiments of the invention therefore ensure a smooth consumption of desired content by a variety of user access devices.

The systems and methods discussed above that utilize a variety of trial-and-error processes for determining file types, formats, and resolutions supported by a variety of user access devices function well when a user does not know what his or her device supports. Of course, most users are relatively unaware of the abilities of their devices, and such methods are therefore very useful to the average user. In instances where the user is more familiar with the capabilities and compatibilities of his or her device, a streamlined method may be used to update the access device characteristics database 60 whereby the user is provided with an opportunity to input one or more file types, sizes, and resolutions supported by the user access device. Regardless of whether such a streamlined process is utilized or even possible, methods in accordance with the disclosed embodiments of the invention allow device users to program or train the access device characteristics database 60 and the accompanying media delivery system without requiring that operators of the system individually program each new device into the system or that such operators even be aware of the existence of new devices before the system is made optimally functional with such new devices.

Systems and methods in accordance with the embodiments depicted and described herein may be useful in file distribution systems for distribution of media files from a plurality of users (e.g. content-generating users) to a plurality of other users (e.g. content consuming users). In such systems, content such as media files may be generated in a plurality of formats, and the content-generating users may not know in what format or formats potential content consuming users will want the media files. Instead of requiring each content generator to provide content directly to each potential content consumer, embodiments of the invention permit the content generator to upload the content to a centralized system, which handles all necessary conversions for the various content generators, and then delivers the converted content to content consuming users. The content consuming users may include a variety of users, such as subscribers to a particular content generator's content.

Thus, embodiments of the invention provide systems and methods for providing access to various media files in formats customized for a receiving device. The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. In a network-based information storage and distribution system for storing and distributing media files to users over a network, a method for updating a database of user access device capabilities to permit the system to provide access to the media files in a format customized for a user access device comprising:
receiving a request at a network-based information storage and distribution system from a user using a user access device that initiates a process for updating a database of user device capabilities;
determining that a file format and/or a size that is compatible with the user access device for providing access to media files is unknown to the system;
determining a file format and/or size for the requested media file that is compatible with the user access device; and
updating the database of user device capabilities with information regarding the compatible file format and/or size for future delivery of media files to the user access device.

2. A method as recited in claim 1, wherein the request that initiates the process for updating the database of user device capabilities comprises one of:
a request to access a file from the system;
a selection of an indicator indicative of trouble in attempting to access a file from the system;
an initial visit to a site provided by the system; and
a request by the user to specifically initiate the updating process.

3. A method as recited in claim 1, wherein determining that the file format and/or a size that is compatible with the user access is unknown comprises:
determining a type of the user access device;
checking the database of user device capabilities for information regarding providing access to the media files to the user access device; and
determining that information regarding providing access to the media files to the user access device is not contained in the database of user device capabilities.

4. A method as recited in claim 1, wherein determining a file format and/or size for the media files that is compatible with the user access device comprises:
delivering content to the user access device in a first format and a first size;
allowing the user to attempt to access the content using the user access device;
receiving information regarding whether the attempt to access the content using the user access device was successful; and
updating the database of user device capabilities with information regarding the success or failure of attempting to access the content using the user access device.

5. A method as recited in claim 4, wherein the first size is a small size, the method further comprising:
determining that the user was able to successfully access the content in the first size;
delivering content to the user access device in successively larger sizes until the user is unable to access the content due to the content being too big; and
updating the database of user device capabilities with information regarding a maximum size capable of being accessed by the user access device.

6. A method as recited in claim 5, wherein the maximum size is one of:
a maximum file size that the user access device can handle; and
a maximum resolution displayable by the user access device.

7. A method as recited in claim 4, wherein determining a file format and/or size for the media files that is compatible with the user access device further comprises:
determining that content in the first format and the first size was not successfully accessed by the user access device;
delivering content to the user access device in at least one of a different size and a different format until the user is able to successfully access the content; and
updating the database of user device capabilities with information regarding the success or failure of each attempt to access the content using the user access device.

8. A method as recited in claim 4, wherein receiving information regarding whether the attempt to access the content using the user access device was successful comprises one of:
receiving selection of an input from the user indicating whether or not the attempt was successful;
receiving an error message from the user access device indicating the attempt was not successful; and
receiving no selection of an input from the user indicating that the attempt was unsuccessful from the user access device, indicative that the content was received and successfully accessed.

9. A method as recited in claim 4, wherein the content delivered to the user access device in determining a file format and/or size for the media files that is compatible with the user access device is one of:
an originally-requested media file in the first format and the first size; and
sample content in the first format and the first size.

10. A method as recited in claim 4, wherein the first format and the first size are selected using a method selected from the group of:
selecting a file format and a size that are commonly compatible with a variety of user access devices;
referencing the database of user access device capabilities and selecting a file format and a size that are commonly compatible with user access devices manufactured by a manufacturer of the user access device making the request;
referencing the database of user access device capabilities and selecting a file format and a size that are commonly compatible with user access devices supported by a service provider associated with the user access device making the request;
referencing the database of user device capabilities to locate a similar user access device having a model number similar to the user access device making the request and selecting a file format and a size that are compatible with the similar user access device; and
randomly selecting a file format and a size.

11. A method as recited in claim 10, wherein selecting the first format and the first size further comprises detecting a communication speed between the system and the user access device and selecting the first format and the first size further based on the detected communications speed.

12. A method as recited in claim 1, wherein the user access device is one of:
a cell phone;
a smart phone;
a netbook;
a laptop computer;
a tablet computer;
a desktop computer;
a workstation;
a personal digital assistant (PDA);
an electronic reader; and
a wireless reading device.

13. In a network-based information storage and distribution system for storing and distributing media files to a user of the media files over a network, a method for updating a database of user access device capabilities to permit the system to provide access to the media files in a format customized for a receiving user device comprising:
receiving a request at a network-based information storage and distribution system from a user using a user access device that initiates a process for updating a database of user device capabilities;
determining that a file format and/or a size that is compatible with the user access device for providing access to media files is unknown to the system, comprising:
determining a type of the user access device;
checking a database of user device capabilities for information regarding how the media files should be formatted and sized to provide access to the media files to the user access device; and
determining that information regarding how the media files should be formatted and sized for the user access device is not contained in the database of user device capabilities;
determining a file format and/or size for the media files that is compatible with the user access device using a trial-and-error method; and
updating a database of user device capabilities with information regarding the compatible file format and/or size for future delivery of media files to the user access device.

14. A method as recited in claim 13, wherein the trial-and-error method comprises:
delivering content to the user access device in a first format and a first size;
allowing the user to attempt to access the content using the user access device;
receiving information regarding whether the attempt to access the content using the user access device was successful; and
updating the database of user device capabilities with information regarding the success or failure of attempting to access the content using the user access device.

15. A method as recited in claim 14, wherein the first size is a small size, the method further comprising:
determining that the user was able to successfully access the content in the first size;
delivering content to the user access device in successively larger sizes until the user is unable to access the content due to the content being too big; and
updating the database of user device capabilities with information regarding a maximum size capable of being accessed by the user access device.

16. A method as recited in claim 14, wherein the trial-and-error method further comprises:
determining that content in the first format and the first size was not successfully accessed by the user access device;
delivering content to the user access device in at least one of a different size and a different format until the user is able to successfully access the content; and
updating the database of user device capabilities with information regarding the success or failure of each attempt to access the content using the user access device.

17. A method as recited in claim 14, wherein the first format and the first size are selected using a method selected from the group of:
selecting a file format and a size that are commonly compatible with a variety of user access devices;
referencing the database of user access device capabilities and selecting a file format and a size that are commonly compatible with user access devices manufactured by a manufacturer of the user access device making the request;
referencing the database of user access device capabilities and selecting a file format and a size that are commonly compatible with user access devices supported by a service provider associated with the user access device making the request;
referencing the database of user device capabilities to locate a similar user access device having a model number similar to the user access device making the request and selecting a file format and a size that are compatible with the similar user access device; and
randomly selecting a file format and a size.

18. In a network-based information storage and distribution system for storing and distributing media files to a user of the media files over a network, a method for updating a database of user access device capabilities to permit the system to provide access to the media files in a format customized for a receiving user device comprising:
receiving a request at a network-based information storage and distribution system from a user using a user access device that initiates a process for updating a database of user device capabilities;
determining that a file format and/or a size that is compatible with the user access device for providing access to the media files is unknown to the system;
determining a file format and/or size for the media files that is compatible with the user access device using a trial-and-error method comprising:
delivering content to the user access device in a first format and a first size;
allowing the user to attempt to access the content using the user access device; and
receiving information regarding whether the attempt to access the content using the user access device was successful; and
continuing delivering content to the user access device in at least one of an additional format and an additional size until a compatible format and size are determined; and
updating a database of user device capabilities with information regarding the compatible format and/or size for future delivery of media files to the user access device.

19. A method as recited in claim 18, wherein the first size is a small size, the method further comprising:
determining that the user was able to successfully access the content in the first size;
delivering content to the user access device in successively larger sizes until the user is unable to access the content due to the content being too big; and
updating the database of user device capabilities with information regarding a maximum size capable of being accessed by the user access device.

20. A method as recited in claim 18, wherein the trial-and-error method further comprises:
determining that content in the first format and the first size was not successfully accessed by the user access device;
delivering content to the user access device in at least one of a different size and a different format until the user is able to successfully access the content; and
updating the database of user device capabilities with information regarding the success or failure of each attempt to access the content using the user access device.

21. A method as recited in claim 18, wherein the first format and the first size are selected using a method selected from the group of:
selecting a file format and a size that are commonly compatible with a variety of user access devices;
referencing the database of user access device capabilities and selecting a file format and a size that are commonly compatible with user access devices manufactured by a manufacturer of the user access device making the request;
referencing the database of user access device capabilities and selecting a file format and a size that are commonly compatible with user access devices supported by a service provider associated with the user access device making the request;
referencing the database of user device capabilities to locate a similar user access device having a model number similar to the user access device making the request and selecting a file format and a size that are compatible with the similar user access device; and
randomly selecting a file format and a size.
